(19) United States
(12) Patent Application Publication
(10) Pub. No.: US 2004/0219845 A1
(43) Pub. Date: Nov. 4, 2004

(54) Fabric reinforced cement

(76) Inventors: Samuel E. Graham, LaGrange, GA (US); George C. McLarty III, Greenville, SC (US)

Correspondence Address: Thomas L. Moses, Legal Department, M-495, PO Box 1926, Spartanburg, SC, 29304, US

(21) Appl. No.: 10/425,905

(22) Filed: Apr. 29, 2003

(51) Int. Cl. B32B 27/04; B32B 27/12; B32B 27/02

(52) U.S. Cl. 442/42; 442/20; 442/21; 442/43; 442/48; 442/149; 442/203; 442/208; 442/209; 442/210; 442/212; 442/213; 442/215; 442/216; 442/217; 442/218; 442/219; 442/220; 442/415

(57) ABSTRACT

A cement panel that is reinforced with a fabric made of carbon fibers. The cement panel includes a core layer that is made of a lightweight cement composition. This core layer is covered with a layer of reinforcing carbon fabric on the top and on the bottom, each bonded to the core with a coating of cementitious material on the top and on the bottom of the core layer. On the edges of the cement panels, the fabric layers are overlapped so as to augment the strength of these edges.

### BACKGROUND OF THE INVENTION

The present invention relates generally to reinforced cementitious panels or boards, and, in particular, cementitious panels or boards that are reinforced with an adhesive bonded fabric that is unaffected by alkali attack.

The use of reinforced cement panels is well known in such industries as the ceramic tile industry. Generally, cement panels or boards contain a core formed of a cementitious material that is interposed between two layers of facing material. The facing materials employed typically share the features of high strength, high modulus of elasticity, and light weight so as to contribute flexural and impact strength to the high compressive strength but brittle material forming the cementitious core. Typically, the facing material employed with cement panels is fiberglass. Fiberglass performs particularly well in this application. Fiberglass provides greater physical and mechanical properties to the cement board. Fiberglass is also an efficient material to reinforce the cement panels because of its relatively low cost when compared with other high modulus materials.

Fiberglass, however, has a major disadvantage, which is its lack of resistance to chemical attack from the ingredients of the cements. Common cements, such as Portland cement, provide an alkaline environment when in contact with water, and the fiberglass yarn that is used in reinforcement fabrics is degraded in these highly alkaline conditions. To overcome this problem, protective polymeric coatings, such as PVC (polyvinyl chloride) plastisol coatings, are applied to the fiberglass. Although these coatings minimize fiberglass degradation, the protective coating on the fiberglass yarns is very critical to the success of the concrete panel. Furthermore, the fiberglass experiences rapid degradation with heat, which typically occurs during the curing phase of the cementitious boards. Therefore, excess fiberglass must be included to ensure a minimum amount of strength over the life of the cement boards.

Accordingly, there remains a need for an improved cement panel that is reinforced by a fabric that both minimizes or eliminates the need to include a protective fabric coating and that retains the beneficial features of other facing materials.

### SUMMARY OF THE INVENTION

According to its major aspects and briefly recited, the present invention is a new and improved cement panel that is reinforced with a fabric made of carbon fibers. The cement panel includes a core layer that is made of a cement composition. This core layer is covered with a layer of reinforcing carbon fabric on the top and on the bottom, each bonded to the core with a coating of cementitious material on the top and on the bottom of the core layer. On the border edge regions of the cement panels, the fabric layers are overlapped so as to augment the strength of these regions.

In a first embodiment, the reinforcement fabric is a bi-directional, adhesive bonded fabric substrate including a plurality of lateral weft yarns that intersect a plurality of warp yarns at right angles and that are bonded at the intersections by an adhesive composition. In a second embodiment, the reinforcement fabric is a tri-directional, also commonly referred to as triaxial, adhesive bonded scrim fabric that is held together by an adhesive composition. As used herein, the term “scrim” shall mean a fabric having an open construction used as a base fabric or a reinforcing fabric. In a triaxial scrim, plural weft yarns having both an upward diagonal slope and a downward diagonal slope are located between plural longitudinal warp yarns that are located on top of the weft yarns and below the weft yarns. In yet another embodiment, a non-woven mat made of carbon fibers may be used in place of the bi-directional or triaxial fabric to reinforce the cement panel.

A feature of the present invention is the use of reinforcement fabric made of carbon fibers in combination with the cement panels. Not only does the use of carbon fibers minimize or altogether eliminate the need for a protective fabric coating, but also carbon possesses the same if not more beneficial features of other facing materials, such as fiberglass. As compared to the typically used fiberglass, carbon has 3 to 6 times the tenacity of fiberglass. Further, carbon breaks at lower elongations than fiberglass. Because the modulus of elasticity of carbon is similar to that cement, the carbon fibers break at elongations in the same range as the cement. Therefore, the cement board or panel is less likely to fail for being too brittle, or too flexible. Carbon is also more resistant to alkali attack than fiberglass. Accordingly, the degradation of the reinforcement fabric due to alkali attack is reduced and the strength of the cement panel throughout its use is increased. Finally, carbon does not experience the same rapid degradation as fiberglass during the curing phase of the cement panels. Therefore, less carbon fiber needs to be employed in the reinforcement of the panels.

Other features and advantages of the present invention will be apparent to those skilled in the art from a careful reading of the Detailed Description of the Preferred Embodiments presented below and accompanied by the drawings.

### BRIEF DESCRIPTION OF THE DRAWINGS

In the drawings,

FIG. 1 is a perspective view of a reinforced cement panel according to a preferred embodiment of the present invention;

FIG. 2 is a top view of a reinforcement fabric for use in combination with cement panels according to a preferred embodiment of the present invention;

FIG. 3 is a top view of a reinforcement fabric for use in combination with cement panels according to an alternative embodiment of the present invention.

### DETAILED DESCRIPTION OF THE PREFERRED EMBODIMENTS

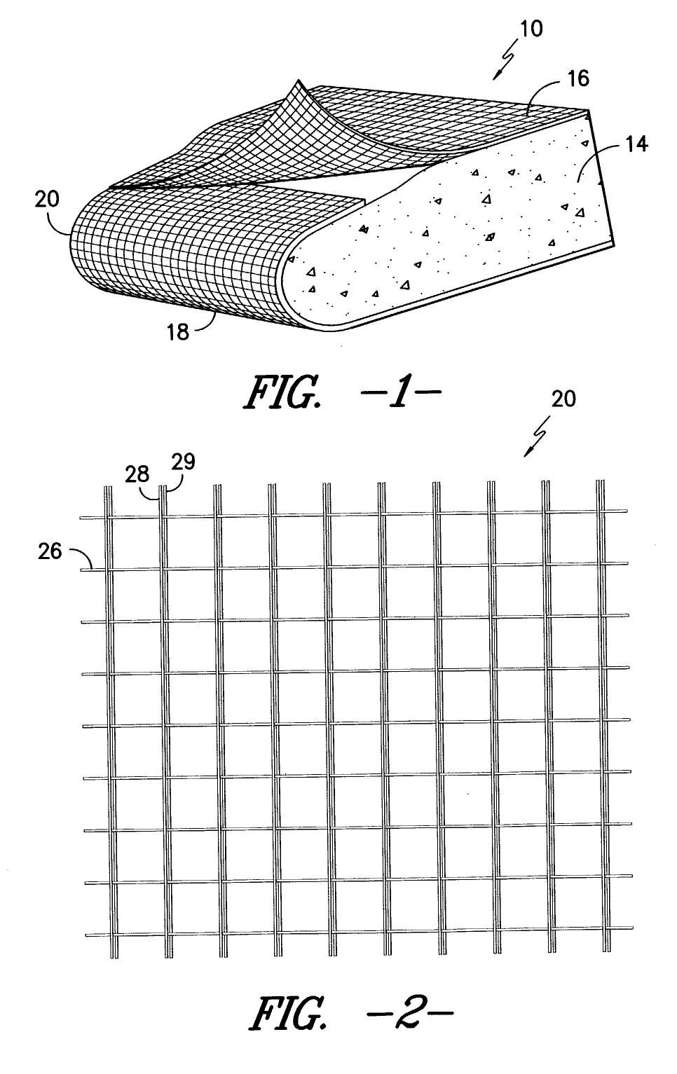

The present invention is a new and improved cement panel 10 that is reinforced with an adhesive bonded fabric 20. As shown if FIG. 1, cement panel includes a core layer 14 that is made of a concrete composition. Core layer 14 is covered by a top layer 16 and a bottom layer 18 of reinforcement fabric 20. Preferably, top layer 16 and bottom layer 18 of fabric 20 overlap on the edge region of the cement panel 10. Because of its cementitious nature, a cement board or panel may have a tendency to be relatively brittle at its edges, which often serve as points of attachment for the boards. Accordingly, by overlaying the fabric 20 at these regions the strength of the cement board edges is augmented and the boards retain sufficient structural integrity such that they remain attached.

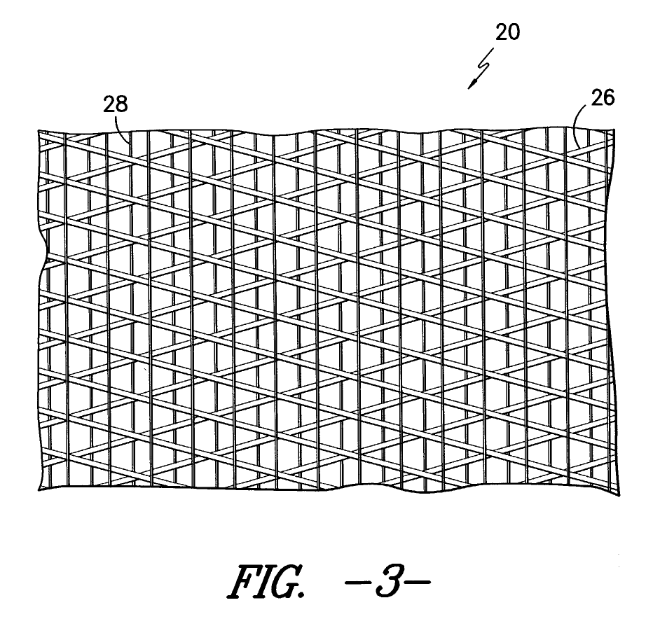

In FIG. 2, there is shown in detail reinforcement fabric 20 according to a first embodiment of the present invention. As illustrated, reinforcement fabric 20 is a bi-directional, adhesive bonded scrim, and includes a layer of parallel weft yarns 26 that are disposed between two convergent layers of parallel warp yarns 28, 29. These yarns are held together by an adhesive, such as polyvinyl alcohol (PVOH), acrylic, polyvinyl acetate, polyvinyl chloride, polyvinylidiene chloride, polyacrylate, acrylic latex or styrene butadiene rubber (SBR), plastisol, or any other suitable adhesive. This adhesive coating is dried upon application so as to stabilize reinforcement fabric 20, thus reducing the shrinkage that can occur after the reinforcement fabric 20 is applied to cement panel 10.

In the preferred fabric construction, warp yarns 28, 29 are disposed at approximately 4 to 18 ends per inch, and the weft yarns 26 are disposed at approximately 4 to 18 ends per inch. Further, warp yarns 28, 29 and weft yarns 26 are preferred in the denier range of 150 to 2000. It is contemplated that the denier of warp yarn 28, 29 and/or weft yarn 26, as well as the number of warp yarns 28, 29 and/or weft yarns 26 per inch can be increased or decreased, as preferred in meeting the strength requirement of the finished cement panel 10.

As previously discussed, the use of carbon fibers to make reinforcement fabric 10 is a particular feature of the present invention. Preferably, both warp yarns 28, 29 and weft yarns 26 are made of carbon fibers. The use of carbon fibers minimizes or eliminates the need for a protective coating over reinforcement fabric 20. Further, carbon includes the same if not more beneficial features of other typically used cement reinforcement materials including high strength, high modulus of elasticity, and lightweight. Finally, carbon does not experience the same rapid degradation as fiberglass during the curing phase of the cement panels. Therefore, less carbon fiber needs to be employed in the reinforcement of the panels

Alternatively, only warp yarns 28, 29 or weft yarns 26 of reinforcement fabric 20 are made of carbon fibers and the corresponding weft yarns 26 or warp yarns 28, 29 are made of fibers such as polyester, polyamides, polyolefin, ceramic, nylon, fiberglass, basalt, and aramid. In another alternative embodiment, the yarns in both the warp and weft direction could include alternating yarns made of carbon fiber and a second fiber such as those listed above. As used herein, the term “alternating” includes any combination of carbon fibers with a second fiber, including both multiple carbon fibers next to multiple second fibers, as well as a single carbon fiber next to a single second fiber. Because the cost of carbon fibers can be relatively high, the use of more inexpensive yarns in combination with carbon yarns can help to decrease the overall cost of manufacture of the reinforcement fabric 20.

FIG. 3 illustrates reinforcement fabric 20 according to a second embodiment. As shown, reinforcement fabric 20 is a tri-directional, or triaxial adhesive bonded scrim fabric that is held together by an adhesive composition, such as polyvinyl alcohol (PVOH), acrylic, polyvinyl acetate, polyvinyl chloride, polyvinylidiene chloride, polyacrylate, acrylic latex or styrenebutadiene rubber (SBR), plastisol, or any other suitable adhesive. In a triaxial construction, plural weft yarns 26 having both an upward diagonal slope and a downward diagonal slope are located between plural longitudinal warp yarns 28 that are located on top of the weft yarns 26 and below the weft yarns 26. The preferred range of the fabric construction of reinforcement fabric 20 is between approximately 4×2×2 (4 ends/inch in the warp direction, and 2 ends per inch on the upward diagonal slope in the weft direction, and 2 ends/inch on the downward diagonal slope in the weft direaction) and 18×9×9, and is most preferably 8×3×3. Further, warp yarns 28 and weft yarns 26 are preferred in a denier range of 150 to 2000.

Similar to the first embodiment, this adhesive coating of reinforcement fabric 20 is dried upon application so as to stabilize reinforcement fabric 20. Preferably, both warp yarns 28 and weft yarns 26 are made of carbon fibers. Alternatively, only warp yarns 28 or weft yarns 26 of reinforcement fabric 20 are made of carbon fibers and the corresponding weft yarns 26 or warp yarns 28 are made of fibers such as polyester, polyamides, polyolefin, ceramic, nylon, fiberglass, basalt, and aramid. In another alternative embodiment, the yarns in both the warp and weft direction could be made of could include yarns made of materials such as those listed between each carbon yarn.

Alternatively, it is contemplated that a non-woven web of carbon fiber may be used as the reinforcement fabric for a cement panel. Such a non-woven web, in a preferred embodiment, is sufficiently open to permit a cementitious core material to penetrate the fabric when the fabric is embedded in one or both major surfaces of the cementitious panel before the cementitious core material hardens. The non-woven carbon fiber web may be made from aligned (carded) or randomly oriented fibers.

Those skilled in the art of cement panels will recognize that many substitutions and modifications can be made in the foregoing preferred embodiments without departing from the spirit and scope of the present invention.

What is claimed is:

1. A reinforced cement panel, comprising:
a core layer of cementitious material; and
a first layer and a second layer of a reinforcement fabric with said core layer therebetween, wherein said first and said second layers each include plural weft yarns that cross plural warp yarns, and wherein at least some of said weft yarns and said warp yarns are at least partially made of carbon fibers.

2. The reinforced cement panel as recited in claim 1, wherein said weft yarns and said warp yarns are made of 100% carbon fiber.

3. The reinforced cement panel as recited in claim 1, wherein said reinforcement fabric is bi-directional.

4. The reinforced cement panel as recited in claim 3, wherein said weft yarns and said warp yarns are disposed at 4 to 18 ends per inch.

5. The reinforced cement panel as recited in claim 1, wherein said weft yarns and said warp yarns are in a denier range from approximately 150 to 2000 denier.

6. The cement panel as recited in claim 1, wherein said reinforcement fabric is tri-directional.

7. The cement panel as recited in claim 6, wherein said reinforcement fabric has a fabric construction of 4 to 18 ends per inch in the warp direction and between 2×2 and 9×9 ends per inch in the weft direction.

8. The cement panel as recited in claim 1, wherein said weft yarns and said warp yarns are made of a combination of said carbon fiber and a fiber that is selected from a group consisting of polyester, polyamides, polyolefin, ceramic, nylon, fiberglass, basalt, aramid, and combinations thereof.

9. The cement panel as recited in claim 1, wherein said weft yarns and said warp yarns are bonded by an adhesive.

10. The cement panel as recited in claim 9, wherein said adhesive is selected from a group consisting of polyvinyl alcohol, acrylic, polyvinyl acetate, polyvinyl chloride, polyvinylidiene chloride, polyacrylate, acrylic latex, styrene butadiene rubber, and plastisol.

11. The cement panel as recited in claim 1, wherein said first layer and said second layer of said reinforcement fabric are overlapped at the edges of said core layer.

12. A reinforced cement panel, comprising:
a core layer of cementitious material; and
a first layer and a second layer of a reinforcement fabric with said core layer therebetween, wherein said first and said second layers each include plural weft yarns that cross plural warp yarns, and wherein at lease some of said plural weft yarns are made of carbon fibers and said plural warp yarns made of a second fiber.

13. The reinforced cement panel as recited in claim 12, wherein said second fiber is selected from a group consisting of polyester, polyamides, polyolefin, ceramic, nylon, fiberglass, basalt, aramid, and combinations thereof.

14. The reinforced cement panel as recited in claim 12, wherein said reinforcement fabric is bi-directional.

15. The reinforced cement panel as recited in claim 12, wherein said reinforcement fabric is tri-directional.

16. A reinforced cement panel, comprising:
a core layer of cementitious material;
a first layer and a second layer of a reinforcement fabric with said core layer therebetween, wherein said first and said second layers each include plural weft yarns that cross plural warp yarns, and wherein at least one of said weft yarns or said warp yarns includes alternating yarns of carbon fiber and a second fiber.

17. The reinforced cement panel as recited in claim 16, wherein said second fiber is selected from a group consisting of polyester, polyamides, polyolefin, ceramic, nylon, fiberglass, basalt, aramid, and combinations thereof.

18. The reinforced cement panel as recited in claim 16, wherein said reinforcement fabric is bi-directional.

19. The reinforcement cement panel as recited in claim 17, wherein said reinforcement fabric is tri-directional.

20. A fabric comprising:
a plurality weft yarns that cross plural warp yarns, wherein at least some of said weft yarns and said warp yarns are at least partially made of carbon fibers.

21. The fabric as recited in claim 20, wherein said weft yarns and said warp yarns are made of 100% carbon fiber.

22. The fabric as recited in claim 20, wherein said reinforcement fabric is bi-directional.

23. The fabric as recited in claim 22, wherein said weft yarns and said warp yarns are disposed at 4 to 18 ends per inch.

24. The fabric as recited in claim 20, wherein said weft yarns and said warp yarns are in a denier range from approximately 150 to 2000 denier.

25. The fabric as recited in claim 20, wherein said fabric is tri-directional.

26. The fabric as recited in claim 25, wherein said fabric has a fabric construction of 4 to 18 ends per inch in the warp direction and between 2×2 and 9×9 ends per inch in the weft direction.

27. The fabric as recited in claim 20, wherein said weft yarns and said warp yarns are made of a combination of said carbon fiber and a fiber that is selected from a group consisting of polyester, polyamides, polyolefin, ceramic, nylon, fiberglass, basalt, aramid, and combinations thereof.

28. The fabric as recited in claim 20, wherein said weft yarns and said warp yarns are bonded by an adhesive.

29. The fabric as recited in claim 28, wherein said adhesive is selected from a group consisting of polyvinyl alcohol, acrylic, polyvinyl acetate, polyvinyl chloride, polyvinylidiene chloride, polyacrylate, acrylic latex, styrene butadiene rubber, and plastisol.

30. A reinforced cement panel, comprising:
a core layer of cementitious material; and
a first layer and a second layer of a reinforcement fabric with said core layer therebetween, wherein said first and said second layers each include a non-woven mat made at least partially of carbon fibers.

31. The reinforced cement panel as recited in claim 30, wherein said non-woven mat includes randomly oriented fibers.

32. The reinforced cement panel as recited in claim 30, wherein said non-woven mat includes aligned fibers.

33. The reinforced cement panel as recited in claim 30, wherein said non-woven mat is made from 100% carbon fibers.

34. A reinforcement fabric for cement panels, said reinforcement fabric comprising a non-woven mat made from 100% carbon fibers.

35. The reinforcement fabric as recited in claim 34, wherein said non-woven mat includes randomly oriented fibers.

36. The reinforcement fabric as recited in claim 34, wherein said non-woven mat includes aligned fibers.
